(19) United States
(12) Patent Application Publication
(10) Pub. No.: US 2016/0033304 A1
(43) Pub. Date: Feb. 4, 2016

(54) COMPOSITE MATERIAL MARKING WAVE

(71) Applicant: Schaeffler Technologies AG & Co. KG, Herzogenaurach (DE)

(72) Inventors: Carsten OHR, Charlotte, NC (US); Brian LEE, York, SC (US)

(73) Assignee: SCHAEFFLER TECHNOLOGIES AG & CO. KG, Herzogenaurach (DE)

(21) Appl. No.: 14/744,428

(22) Filed: Jun. 19, 2015

Related U.S. Application Data
(60) Provisional application No. 62/032,127, filed on Aug. 1, 2014.

(51) Int. Cl. G01D 5/20

(52) U.S. Cl. CPC G01D 5/2013

(57) ABSTRACT

A position sensor for a bearing arrangement is provided. The position sensor includes at least one shaft or bearing ring, an inductive sensor, and a composite marking ring connected to the at least one shaft or bearing ring. The composite marking ring is spaced apart from and aligned with the inductive sensor and includes a ferrous material ring having a wavy surface with a plurality of projections with valleys therebetween facing the inductive sensor. The inductive sensor detects a rotational angle position of the at least one shaft or bearing ring based on a proximity of the wavy surface to the inductive sensor. An outer layer formed of a filler material is arranged at least on the wavy surface of the ferrous material ring. The filler material comprises a non-ferrous material and the outer layer provides a constant predetermined spacing between the composite marking ring and the inductive sensor.

INCORPORATION BY REFERENCE

The following documents are incorporated herein by reference as if fully set forth: U.S. Provisional Patent Application No. 62/032,127, filed Aug. 1, 2014.

### FIELD OF INVENTION

The present invention relates to a bearing arrangement used to detect torque and angular speed of a supported shaft or bearing ring.

### BACKGROUND

Bearing arrangements including sensors for detecting a position of the bearing are known. Known position sensors for bearing arrangements typically require an inductive sensor and a marking ring including a wavy surface comprised of a ferrous material. The inductive sensor detects a rotational angle position of a shaft or bearing ring connected to the marking ring based on a proximity of the wavy surface to the inductive sensor. Due to the projections and valleys along the wavy surface of the marking ring, the marking ring can collect debris or contaminants, causing interference of the magnetic flux between the ferrous marking ring and the inductive sensor and incorrect position readings. It would be desirable to provide a simple way to prevent the marking ring from collecting debris and contaminants.

### SUMMARY

A position sensor for a bearing arrangement with a simplified configuration that prevents debris and contaminants from adhering to a marking ring is provided. The position sensor includes at least one shaft or bearing ring, an inductive sensor, and a composite marking ring connected to the at least one shaft or bearing ring. The composite marking ring is spaced apart from and aligned with the inductive sensor, and includes a ferrous material ring having a wavy surface with a plurality of projections with valleys therebetween facing the inductive sensor. The inductive sensor detects a rotational angle position of the at least one shaft or bearing ring based on a proximity of the wavy surface to the inductive sensor. An outer layer formed of a filler material is arranged at least on the wavy surface of the ferrous material ring. The filler material comprises a non-ferrous material and the outer layer provides a constant predetermined spacing between the composite marking ring and the inductive sensor.

A method of detecting a rotational angle position of at least one shaft or bearing ring of a bearing arrangement is also provided. The method includes providing at least one shaft or bearing ring, an inductive sensor, and a composite marking ring connected to the at least one shaft or bearing ring, spaced apart from and aligned with the inductive sensor. The composite marking ring includes a ferrous material ring having a wavy surface with a plurality of projections with valleys therebetween facing the inductive sensor. An outer layer formed of a filler material is arranged at least on the wavy surface of the ferrous material ring. The filler material comprises a non-ferrous material and provides a constant predetermined spacing between the composite marking ring and the inductive sensor. The method includes detecting a rotational angle position of the at least one shaft or bearing ring based on a proximity of the wavy surface to the inductive sensor.

### BRIEF DESCRIPTION OF THE DRAWINGS

The foregoing Summary and the following detailed description will be better understood when read in conjunction with the appended drawings, which illustrate a preferred embodiment of the invention. In the drawings:

FIG. 1A shows a front plan view of a position sensor according to a first embodiment.

FIG. 1B is a cross-sectional view along line 1B-1B in FIG. 1A.

FIG. 2A shows a top view of a position sensor according to a second embodiment.

FIG. 2B shows a front plan view of the position sensor of FIG. 2A.

FIG. 2C is a cross-sectional view along the line 2C-2C in FIG. 2B.

FIG. 3A shows a front plan view of a position sensor according to a third embodiment.

FIG. 3B is a cross-sectional view along the line 3B-3B in FIG. 3A.

FIG. 4A shows a top view of a position sensor according to a fourth embodiment.

FIG. 4B shows a front plan view of the position sensor of FIG. 4A.

FIG. 4C is a side cross-sectional view along the line 4C-4C in FIG. 4B.

FIG. 5 shows a cross-sectional view of a position sensor according to a fifth embodiment.

### DETAILED DESCRIPTION OF THE PREFERRED EMBODIMENTS

Certain terminology is used in the following description for convenience only and is not limiting. The words “front,” “rear,” “upper” and “lower” designate directions in the drawings to which reference is made. The words “inwardly” and “outwardly” refer to directions toward and away from the parts referenced in the drawings. “Axially” refers to a direction along the axis of a shaft. A reference to a list of items that are cited as “at least one of a, b, or c” (where a, b, and c represent the items being listed) means any single one of the items a, b, or c, or combinations thereof. The terminology includes the words specifically noted above, derivatives thereof and words of similar import.

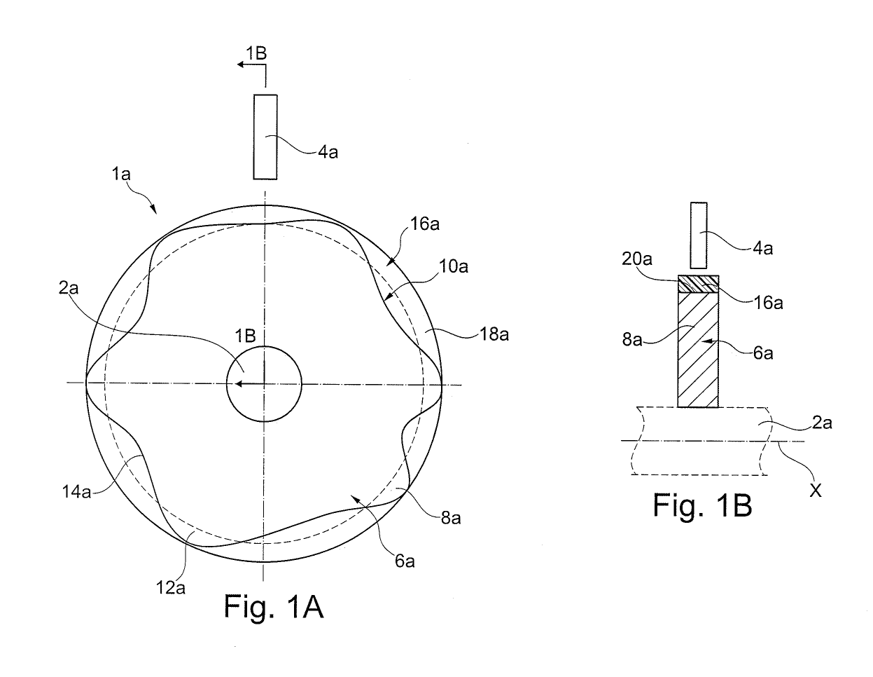

FIGS. 1A and 1B show a position sensor 1a for a bearing arrangement according to a first embodiment. The position sensor 1a includes at least one shaft or bearing ring 2a (shown in phantom lines), an inductive sensor 4a, and a composite marking ring 6a connected to the at least one shaft or bearing ring 2a. The at least one shaft or bearing ring 2a is shown as a shaft in FIGS. 1A and 1B, however, one of ordinary skill in the art recognizes a bearing ring could also be used. The composite marking ring 6a is spaced apart from and aligned with the inductive sensor 4a. The composite marking ring 6a includes a ferrous material ring 8a having a wavy surface 10a with a plurality of projections 12a and valleys 14a therebetween facing the inductive sensor 4a. In one embodiment, the ferrous material ring 8a is formed from steel. The inductive sensor 4a detects a rotational angle position of the at least one shaft or bearing ring 2a based on a proximity of the wavy surface 10a to the inductive sensor 4a. An outer layer 16a formed of a filler material 18a is arranged at least on the wavy surface 10a of the ferrous material ring 8a. The filler material 18a comprises a non-ferrous material and the outer layer 16a provides a constant predetermined spacing between the composite marking ring 6a and the inductive sensor 4a. In one embodiment, the filler material 18a is comprised of a polymeric material. In other embodiments, the filler material 18a can be comprised of ceramic or aluminum. In one embodiment, the ferrous material ring 8a and the outer layer 16a are molded together. In another embodiment, the ferrous material ring 8a and the outer layer 16a are cast together. One of ordinary skill in the art recognizes a variety of fastening means, such as baking or sintering, can be used to attach the ferrous material ring 8a and the outer layer 16a.

The outer layer 16a provides a constant outer diameter of the composite marking ring 6a and prevents any debris or contaminants from becoming lodged in and/or adhering to the wavy surface 10a, which can cause imprecise readings due to interference with the magnetic flux between the ferrous material ring 8a and the inductive sensor 4a. As shown in FIGS. 1A and 1B, the wavy surface 10a is formed on a radially outer surface 20a of the ferrous material ring 8a, and the outer layer 16a forms a constant outer diameter of the composite marking ring 6a.

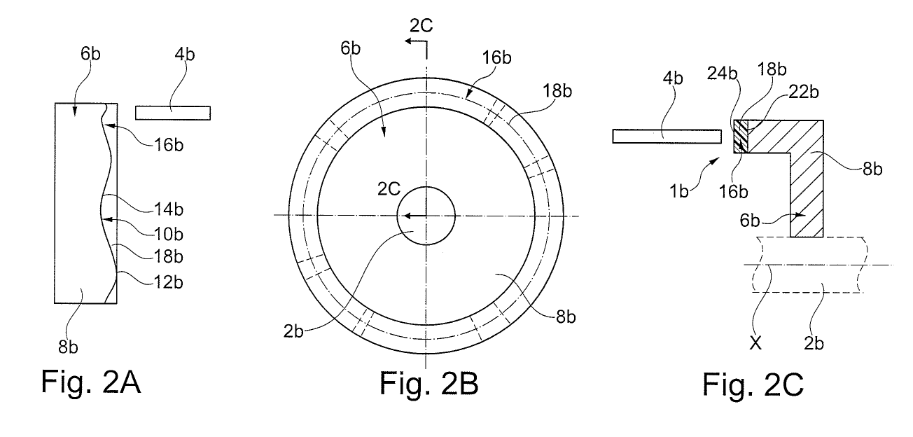

In another embodiment shown in FIGS. 2A-2C, the wavy surface 10b is formed on an axial end surface 22b of the ferrous material ring 8b, and the outer layer 16b forms a planar axial end surface 24b of the composite marking ring 6b. This arrangement is functionally identical to the arrangement shown in FIGS. 1A and 1B, except the inductive sensor 4b is spaced axially away from the filler material 18b, composite marking ring 6b, and outer layer 16b.

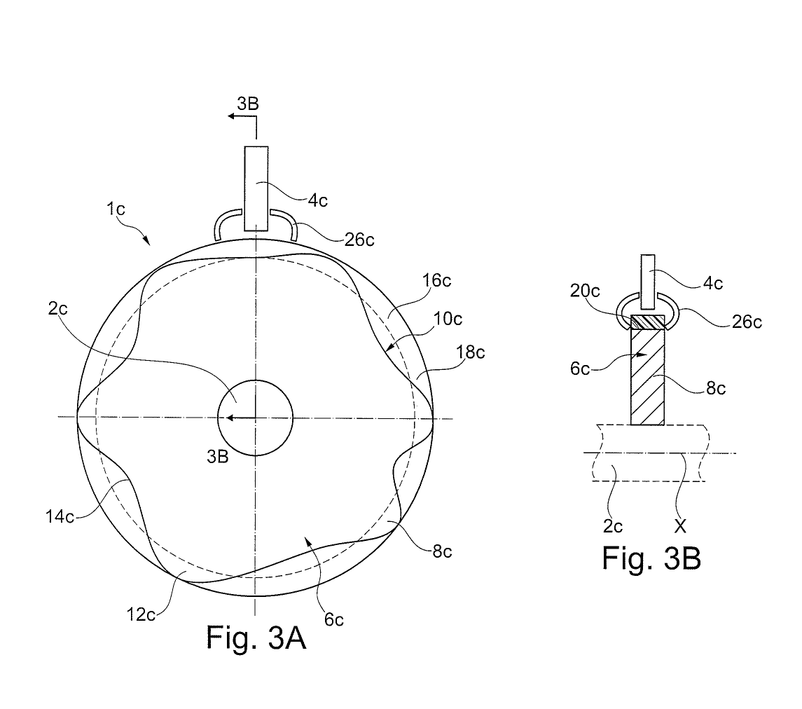

In another embodiment shown in FIGS. 3A and 3B, a ferrous material ring 8c is provided having filler material 18c on the radially outer surface. A seal 26c is arranged between the outer layer 16c and the inductive sensor 4c. The seal 26c serves as additional protection against any debris or contaminants from entering the space between the inductive sensor 4c and the outer layer 16c. The seal 26c can be formed from a polymeric material, or any other material capable of providing a rigid seal between the surfaces of the inductive sensor 4c and the outer layer 16c.

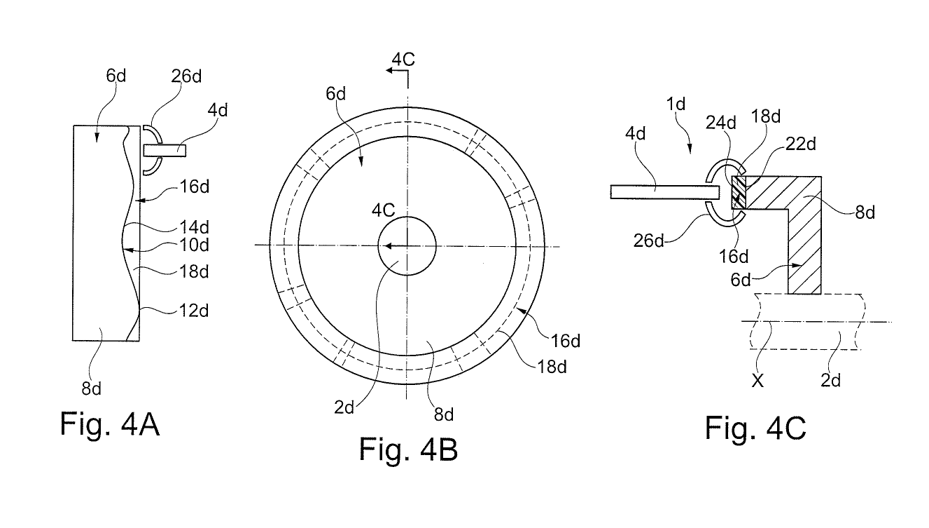

The embodiment shown in FIGS. 4A-4C is identical to the embodiment shown in FIGS. 2A-2C, except this embodiment includes a seal 26d. The remaining element numbers are the same, except they are identified with “d”. For example, the ferrous material ring 8d corresponds with the ring 8b of the second embodiment. The seal 26d prevents the ingress of any debris or contaminants to the space between the inductive sensor 4d and the planar axial end surface 24d of the composite marking ring 6d.

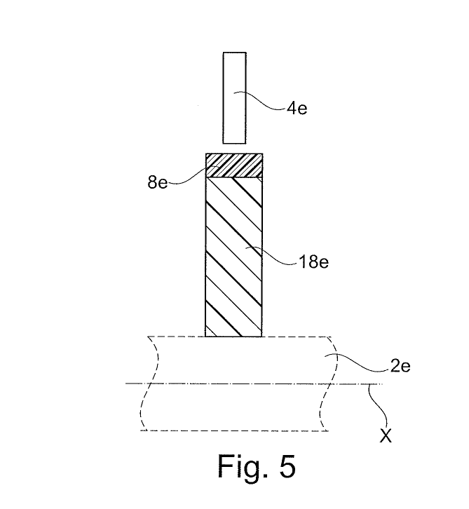

The embodiment shown in FIG. 5 is similar to FIG. 1B except the filler material and ferrous ring positions are switched. In FIG. 5, the filler material 18e is arranged on the at least one shaft or bearing ring 2e, and the ferrous ring 8e is arranged on a radially outer surface of the filler material 18e. One of ordinary skill in the art recognizes the filler material and ferrous ring arrangement shown in FIGS. 2A-2C could also be switched.

A method of detecting a rotational angle position of at least one shaft or bearing ring 2a-2e of a bearing arrangement 1a-1e is also provided. The method includes providing at least one shaft or bearing ring 2a-2e, an inductive sensor 4a-4e, and a composite marking ring 6a-6e connected to the at least one shaft or bearing ring 2a-2e, spaced apart from and aligned with the inductive sensor 4a-4e. The composite marking ring 6a-6e includes a ferrous material ring 8a-8e having a wavy surface 10a-10e with a plurality of projections 12a-12e with valleys 14a-14e therebetween facing the inductive sensor 4a-4e. An outer layer 16a-16e formed of a filler material 18a-18e is arranged at least on the wavy surface 10a-10e of the ferrous material ring 8a-8e. The filler material 18a-18e comprises a non-ferrous material and provides a constant predetermined spacing between the composite marking ring 6a-6e and the inductive sensor 4a-4e. The method includes detecting a rotational angle position of the at least one shaft or bearing ring 2a-2e based on a proximity of the wavy surface 10a-10e to the inductive sensor 4a-4e.

One of ordinary skill in the art would recognize that a magnetic and non-magnetic material could be used in place of the ferrous and non-ferrous materials described above. A combination of ferrous and magnetic materials could also be used, as long as a contrast in the material properties of the marking rings 6a-6e, rings 8a-8e and the filler components 18a-18e is detectable by the sensor 4a-4e as discussed above.

Having thus described the presently preferred embodiments in detail, it is to be appreciated and will be apparent to those skilled in the art that many physical changes, only a few of which are exemplified in the detailed description of the invention, could be made without altering the inventive concepts and principles embodied therein. It is also to be appreciated that numerous embodiments incorporating only part of the preferred embodiment are possible which do not alter, with respect to those parts, the inventive concepts and principles embodied therein. The present embodiment and optional configurations are therefore to be considered in all respects as exemplary and/or illustrative and not restrictive, the scope of the invention being indicated by the appended claims rather than by the foregoing description, and all alternate embodiments and changes to this embodiment which come within the meaning and range of equivalency of said claims are therefore to be embraced therein.

What is claimed is:

1. A position sensor for a bearing arrangement, the position sensor comprising:
at least one shaft or bearing ring;
an inductive sensor;
a composite marking ring connected to the at least one shaft or bearing ring, spaced apart from and aligned with the inductive sensor, the composite marking ring including a ferrous material ring having a wavy surface with a plurality of projections with valleys therebetween facing the inductive sensor, such that the inductive sensor detects a rotational angle position of the at least one shaft or bearing ring based on a proximity of the wavy surface to the inductive sensor, and an outer layer formed of a filler material arranged at least on the wavy surface of the ferrous material ring, the filler material comprises a non-ferrous material and the outer layer provides a constant predetermined spacing between the composite marking ring and the inductive sensor.

2. The position sensor of claim 1, wherein the wavy surface is formed on a radially outer surface of the ferrous material ring, and the outer layer forms a constant outer diameter of the composite marking ring.

3. The position sensor of claim 1, wherein the wavy surface is formed on an axial end surface of the ferrous material ring, and the outer layer forms a planar axial end surface of the composite marking ring.

4. The position sensor of claim 1, wherein a seal is arranged between the outer layer and the inductive sensor.

5. The position sensor of claim 1, wherein the filler material comprises a polymeric material.

6. The position sensor of claim 1, wherein the ferrous material ring is formed from steel.

7. The position sensor of claim 1, wherein the ferrous material ring and the outer layer are molded together.

8. The position sensor of claim 1, wherein the ferrous material ring and the outer layer are cast together.

9. A method of detecting a rotational angle position of at least one shaft or bearing ring of a bearing arrangement, the method comprising:
providing at least one shaft or bearing ring, an inductive sensor, a composite marking ring connected to the at least one shaft or bearing ring, spaced apart from and aligned with the inductive sensor, the composite marking ring including a ferrous material ring having a wavy surface with a plurality of projections with valleys therebetween facing the inductive sensor, and an outer layer formed of a filler material arranged at least on the wavy surface of the ferrous material ring, the filler material comprises a non-ferrous material and provides a constant predetermined spacing between the composite marking ring and the inductive sensor; and
detecting a rotational angle position of the at least one shaft or bearing ring based on a proximity of the wavy surface to the inductive sensor.
